(19) United States
(12) Patent Application Publication
(10) Pub. No.: US 2018/0357316 A1
(43) Pub. Date: Dec. 13, 2018

(54) Arrangement and related method for provision of video items

(71) Applicant: BCaster Oy, Savonlinna (FI)

(72) Inventors: Janne Neuvonen, Savonlinna (FI); Seppo Sormunen, Savonlinna (FI); Olli Rantula, Savonlinna (FI)

(73) Assignee: BCaster Oy, Savonlinna (FI)

(21) Appl. No.: 15/619,667

(22) Filed: Jun. 12, 2017

(51) Int. Cl. G06F 17/30

(52) U.S. Cl. CPC G06F 17/30817; G06F 17/3087; G06F 17/30858; G06F 17/30849

(57) ABSTRACT

An arrangement, optionally comprising one or more network accessible servers, for searching for digital video material, wherein the arrangement comprises at least one processor configured to receive a number of video items: store the video items in a database; provide metadata, preferably a number of tags, for any or each video item wherein said metadata is obtained through utilizing supplementary data provided by at least one user device via which said video item has been obtained; receive a search query wherein at least one search criterion comprised in the search query is related to said metadata; determine video item search results matching the search query among said at least one video item stored in the database; and provide an output to a user comprising the video item search results, wherein the video item is related to time duration and said provided metadata comprises at least one quality indicator, which is determined through analysis of said supplementary data related to one or more subitems of the video item, wherein a subitem is related to a subduration of thereof, and said at least one quality indicator is assigned to a corresponding subitem. A corresponding method is presented.

### TECHNICAL FIELD OF THE INVENTION

The present invention is related to provision and consumption of video material. More specifically, however not exclusively, the present invention provides an arrangement and method for searching for digital video items, such as video clips, wherein metadata is provided through utilization of data obtained from or via devices with which said video items have been captured. Search criteria may be related to such metadata.

### BACKGROUND OF THE INVENTION

In the past years, advancements in camera technology and mobile devices have led to a substantial rise in the amount of video footage being recorded by mobile devices such as smartphones and tablets. Much of this footage is uploaded to social media sites through which users may search interesting video footage using preferred search criteria. The search criteria are typically used to search matching metadata associated with video footage such as different video clips. Relevant metadata may be associated with a video clip through tagging, done by the recorder of the video material or the uploader of the material.

Searching for video material taken at a specific event is usually rather difficult, as searches are typically conducted through specifying search words. The search words used may be related to the specific event, but video material taken at the event may not have been tagged using these words and is thus not found. Video material may also have been tagged erroneously by the tagger.

The vast amount of video material available may also lead to such a large amount of search results that it may be practically impossible for a conductor of the search to review them.

Methods for organizing the search results may thus include relevance according to metadata based tagging, which is problematic due to reasons stated above, including lacking and erroneous (meta)data. Organizing may also be done through popularity based on the number of views or on ratings given by viewers, but this is again subjective and somewhat non-informative in many cases.

Traditional video search methods may also provide information regarding quality of the videos. Still, this may be problematic and misleading, as video quality may vary drastically even within a certain video. The assessment of quality itself is often also rather difficult, because quality is a rather subjective measure and if the users of video items such as uploaders or downloaders may themselves rate the quality, the used scale may mean different things to different people, whereupon the issued quality ratings are easily mutually uncomparable.

It is possible to combine videos taken at a specific event to form a compilation of e.g. videos taken from different angles or directions. However, tools for easily constructing such complication e.g. upon need and with minimum or at least reduced necessary user input are currently unavailable. Available tools require quite a bit of manual work and effort, special expertise around video editing, wading through different video clips for selection in the compilation, etc.

### SUMMARY OF THE INVENTION

An object of the invention is to alleviate at least some of the problems relating to the known prior art.

The arrangement of the present invention is characterized by what is stated in attached claim 1. The method of the present invention is characterized by what is stated in attached claim 19.

The present invention offers a plethora of advantages over the known prior art, such as providing an intuitive, easy-to-use dynamic arrangement for searching for video items through preferably automatically generated metadata. As metadata is not specified by an uploader or recorder of the video item, errors, either intentional or accidental, may not be made by the uploader or recorder, and are thus avoided.

Utilizing an embodiment of the present invention, any video item recorded at a specific time or place that has been uploaded may be searched and downloaded from an associated system, such as a server arrangement optionally implemented utilizing a cloud computing environment, by using the time and place (of capture as indicated by supplementary data associated with the video item) as search criteria.

An arrangement may provide many different ways of displaying search results to a user of the arrangement. In an advantageous embodiment, the search results are provided to a user of the arrangement so that video quality may also be indicated through at least one quality indicating parameter, where such quality parameter, or ‘indicator’, has been advantageously determined as metadata through data obtained via sensors of the device through which the video material has been obtained, such as a smartphone, tablet, or other terminal device, or a camera device provided with or at least functionally connected to a communication device. This metadata may preferably be generated automatically by the arrangement. Utilizing the present invention, video material from an event may be conveniently searched for and found, with the additional benefit of providing search results indicative of video quality, in which case a user of the arrangement may choose not to view video items of poor quality. Quality or other metadata, such as tags, associated with a video item may be generated based on data acquired from sensors, such as image (e.g. the image sensor itself used for capturing the video), sound, position and/or acceleration/inertial sensors.

A video item may comprise one or more, nowadays typically digital, video files, or clips, or at least one or more video frames, which are related to a duration, which may be considered a temporal ‘length’ or ‘extent’, of the video item in question, being also indicative of the related recording, or ‘shooting’, duration.

A video item may be perceived to be the result of substantially continuous recording having a certain frame rate, or sampling rate, typically but not necessarily falling within a range from at least about 10 or 15 Hz to e.g. about 25, 50, 100 Hz or higher. The rate may be static or dynamic within an item. Video quality may be advantageously assessed and preferably also indicated individually for a segment of the video or even separately for each video frame, giving the additional benefit of possibly indicating to a user if only part of a video is of good or bad quality. The video quality may then be assessed through analysis of two or more subitems of the video item, where the subitem is related to a subduration. Assessment and e.g. related tagging may take place at a recording device or e.g. the receiving (server) arrangement, or by a third party system. Quality may be assessed e.g. on a predetermined scale, so that a user may be aware of the degree of quality of e.g. segments of a video. Alternatively or additionally, an average quality of a video item may optionally be communicated to a user. The scale or quality in general may be based on e.g. frame rate, resolution, stability, focus, field of view, etc. evaluated utilizing e.g. some more widely adopted standard or a proprietary solution, and/or based on user-selectable settings.

In some embodiments also other search criteria may be given that may be related to automatically generated metadata. In one embodiment, for instance metadata obtained through image analysis may be utilized. In an exemplary use scenario, a user of the arrangement may have a desire to find video material taken at a specific event such as a sports event in which a specific player is visible. This may be specified in the user's search query as for example a player (sur)name or number, and in the search results the arrangement may then provide video items of the event in which the player in question is visible, where the player number has been detected through image analysis of the video footage, essentially involving e.g. pattern recognition, and has been added to the video metadata.

Related to the above example, in an embodiment the arrangement may also, if desired, produce a video compilation of the event in which e.g. a specific player or team is featured exclusively or with positive or negative emphasis, and video items in which the player or team is visible may be compiled, for instance. Also other material, for example audio material may be integrated with the video material.

Video compilations may be generated through utilization of various types of automatically generated metadata. For example time, a direction or angle in which the video has been taken with respect to an event, or certain objects being visible in the video footage may be taken into account. In an embodiment, video quality may have been assessed individually for subitems of a video item. A potential benefit may then be that video compilations with only high or sufficient quality video subitems according to e.g. user-determined criteria are created.

The benefits explained above may substantially decrease the amount of time that is required to perform video searches. Human labor and computational resources may be saved, as video compilations may be automatically generated even dynamically, in some cases substantially in real-time fashion, responsive to user input such as search queries including criteria given by a user.

In some embodiments, the arrangement may be utilized by private users, whereas in some other embodiments professional users such as reporters or news stations may obtain video material of an event for distribution, publishing or other purposes. Relevant and high-quality footage may be acquired swiftly and with ease through the arrangement. Also, time needed and expenses required may be reduced in the news production process, as reporters may not have to travel to a specific location in order to obtain video footage. A best angle or direction from which video footage is taken may for instance also be found through the arrangement.

Also, video material obtained even accidentally of an event, perhaps something happening unexpectedly, may be searched for. This feature may be utilized for example by law enforcement agencies to investigate possible criminal events or search for individuals suspected of committing a crime. Yet, e.g. fire brigades or other emergency units may exploit the available data in performing their duties.

Embodiments of the present invention may provide novel methods for news providers or any other private or corporate instance to purchase or generally acquire video content. Through an embodiment of the arrangement, a user may obtain access rights or exclusive rights of video content, and a method of conducting payment to the content uploader may be provided. If exclusive rights to content are purchased or otherwise issued, the content in question may be removed from the database.

The price of access or exclusive rights may in different embodiments be determined through e.g. auctions, or pricing may be determined automatically by the arrangement based on video content and/or quality analysis. Alternatively or in addition, also other parameters may affect pricing, such as demand or generally popularity of video items in question, which may be estimated based on e.g. search term statistics available.

Different user rights for an arrangement may also be provided along with different user profile categories. For instance, a user may obtain a user profile free of charge, and may be provided more limited possibilities to search for video content acquired only e.g. in predetermined locations. A fee, for example a monthly fee, may then be charged for user profiles in which available search locations or other search criteria are expanded.

Through embodiments of the invention, specific events, locations or instants may also be blocked, so that a group of users or any user may not have access to video material obtained at the event or location, or at a particular instant. The blocking may be temporary or permanent and may be determined manually (e.g. by the operator of the arrangement) or automatically based on information or triggers acquired through external sources. For instance, an accident site may be reported through an emergency response center (automatically or manually), whereupon the emergency site and optionally adjacent region may be automatically blocked by the arrangement due to e.g. ethical considerations and/or may, alternatively, be set as a location to be specifically monitored.

In other aspects, the invention may provide means for uploading video items automatically to a server optionally depending on the settings of the recording terminal or e.g. user account associated therewith. All videos taken using a specific device may, if desired, be uploaded to a server automatically and without unnecessary delay. This way, video items may be available for search briefly, optionally essentially in real-time, and one does not need to remember to manually trigger uploading video material. In one embodiment, an application for a mobile device may be provided, and all video material captured by the device while the application is running or set in some specific mode or state, e.g. active state, may be automatically uploaded to a server.

Automatic initial tagging of metadata done through e.g. image analysis methods may also be corrected, adjusted or otherwise altered using external data resources. In the case of a marathon, for instance, the arrangement may have mistakenly assigned a tag referring to a competitor number “26” to a video footage, when the footage is actually of a competitor with the number “28”. Timing result records for the marathon may be provided, from which it is may be possible in some cases to verify that the competitor “26” could not have been at the location in question at the time that the video footage was captured. In this case, the arrangement may determine that assigning metadata/tagging has originally been erroneous, and through image analysis, the associated tag may be revised to refer to a competitor “28”.

Applications with user interfaces comprising various advantageous features may be provided for the devices of users of an arrangement. For instance, for a content providing user, a user interface (UI) may be provided through which video content may be easily captured. The user interface may comprise a multifunctional record button which may be manipulated to initiate or terminate video recording and additionally also communicate, in real-time to the content providing user, information related to the video that is being recorded or may be recorded at the given instant, for example.

The multifunctional record button or similar UI feature may also be cleverly repositioned by the content providing user or automatically, for instance, to a desired location on a screen of a recording device. This ensures that the record button may at all times be located at an optimal position for the content providing user, where the optimal position may depend, for instance, on the handedness or length of fingers of the content providing user.

In an embodiment, the multifunctional record button may also be resized (enlargened, reduced, and/or otherwise redimensioned) automatically or by the content providing user. The multifunctional record button may then be set to a size according to a (user) preference or may be resized to ensure e.g. that the content providing user has desired visibility of the screen of the recording device in which case the size of the button should not exceed e.g. a selected limit of the screen or window size.

In one embodiment, using a user interface, a searching user may, after providing a search query with a time and location (e.g. indication of location-specific target event or more explicit indication of a geographic location, such as address, coordinates, city or region name), view on a map where in the vicinity of the given location videos have been captured at the provided time. The quality and/or point of view or direction from which the video has been shot or a field of view of the videos may also be communicated to the searching user. The user interface may comprise a timeline which may be navigated by the searching user, where manipulation of the timeline may result in the searching user being able to view, through the aforementioned map, changes with time in the provided information being related to videos that are available from the map region. In an embodiment, a user interface may additionally show one or more of the videos indicated in the map at the time which is given at the timeline. The videos may be played and the timeline may be allowed to proceed, while the map view changes accordingly. A searching user may also manipulate the timeline to view video frames and/or map configurations corresponding to a desired time in the vicinity of the time expressed through the search query. In some embodiments, the time and location may also be chosen or varied by the searching user after a search query has been given.

The claims and description do not pose limitations to the number of users, either searching or content providing, that may utilize the invention simultaneously or at different times. At a given time, any number of users may exist, or there may be one or no users. From a technical standpoint, the disclosed arrangement may be assigned, optionally dynamically e.g. from a cloud, the necessary hardware in terms of required processing, storage, and communications capacity for serving the users thereof.

The term “time” may herein refer to a date, an exact time (e.g. per second or fraction of a second) on a specific date, or a time interval, such as a time within a predetermined time limit from another time. The term “location” may refer to a specific location, such as coordinates, or a region such as a city, or a region which may be specified as residing within a predetermined distance from a specific location.

The term “plurality” refers herein to a number of two or more. The term “number” refers to one or more.

The exemplary embodiments presented in this text are not to be interpreted to pose limitations to the applicability of the appended claims. The verb “to comprise” is used in this text as an open limitation that does not exclude the existence of unrecited features. The features recited in depending claims are mutually freely combinable unless otherwise explicitly stated.

The novel features which are considered as characteristic of the invention are set forth in particular in the appended claims. The invention itself, however, both as to its construction and its method of operation, together with additional objects and advantages thereof, will be best understood from the following description of specific example embodiments when read in connection with the accompanying drawings.

The previously presented considerations concerning the various embodiments of the arrangement may be flexibly applied to the embodiments of the method mutatis mutandis, and vice versa, as being appreciated by a skilled person.

### BRIEF DESCRIPTION OF THE DRAWINGS

Next the invention will be described in greater detail with reference to exemplary embodiments in accordance with the accompanying drawings, in which:

FIG. 1 illustrates an exemplary arrangement according to one embodiment of the invention,

FIG. 2 shows an exemplary application view of a first user interface according to an embodiment of the invention,

FIG. 3 shows an exemplary application view of a second user interface according to an embodiment of the invention, and

FIG. 4 depicts steps that may be executed in a method according to an embodiment of the invention.

### DETAILED DESCRIPTION

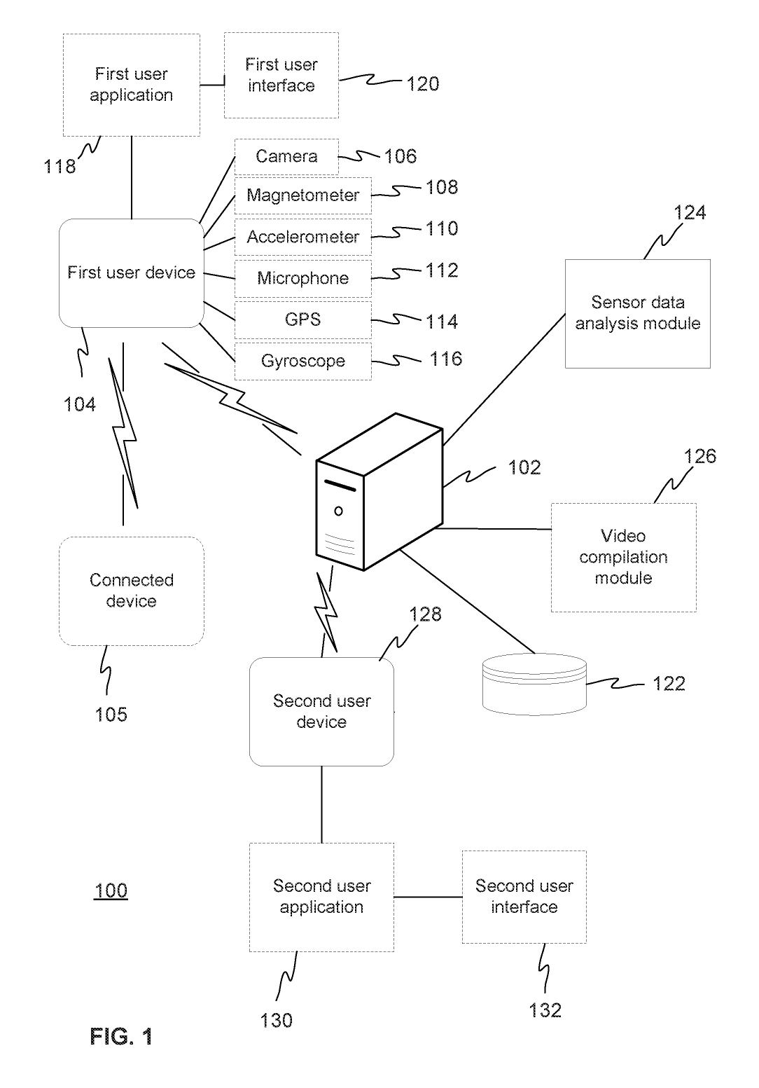

FIG. 1 gives an exemplary arrangement 100, optionally comprising one or more server computers and/or other network side elements implementing e.g. a network service for distribution of videos, according to one embodiment of the invention.

In more detail, the arrangement 100 comprises a processor 102, which may receive a video item from a first user device 104, which is a content providing user device, where the user device 104 may be a mobile device such as a mobile phone or a tablet. In some embodiments, the video item may be received from the device 104 as a stream e.g. in substantially real-time fashion upon capturing, whereas in other embodiments, a ready-captured complete item such as a video file, or ‘clip’, may be received after capturing phase. The processor 102 may indeed reside in at least one remote server, and the receiving of a video item may be realized utilizing e.g. at least partially wireless communication between the server or processor 102 and the user device 104. For storing data e.g. in at least one database 122, the server, or the arrangement 100 in general, may include memory and for communication purposes, a communications interface such as wireless or wired transceiver, e.g. a transceiver operable in a LAN (local area network) network. In practice, the arrangement 100 may be coupled via the interface to a communications network, such as the internet, whereto the device 104 also has access via a wireless link of a related wireless, optionally cellular or Wi-Fi type, network.

The first user device 104 may, in addition to a processor, memory and e.g. communication interface (e.g. a wireless transceiver), comprise a plurality of sensors, at least a camera 106 (image sensor capturing visible and/or invisible such as infrared frequencies; the latter could provide e.g. thermal images for temperature estimation and/or heat-based object/subject locating purposes) and additionally other sensors, such as a magnetometer 108, an accelerometer 110, a microphone 112, a GPS sensor 114, and/or a gyroscope 116 or still a further inertial sensor. Further applicable sensors include e.g. temperature, moisture and pressure sensors. Sensor data from sensors in the first user device 104 (the sensor data being acquired at the time of capturing the video item and associated with the capturing instant in the video item or the video item in general, possibly depending on the particular data item), may be received by the processor 102. Additionally, other data may be received by the processor 102 through the first user device 104, such as temporal data (capture time, duration, etc.) related to the video item.

An arrangement may additionally or alternatively in some embodiments comprise secondary content providing devices or secondary user devices 105.

These devices 105 external to the first user device 104 may comprise sensors that acquire and transmit data, e.g. as a stream or ready-captured complete item (e.g. file), to a first user device 104 through wired or wireless communication. The first user device 104 may then transmit the data (as such or in adapted form) and possibly other data, e.g., from sensors comprised in the first user device 104, to the processor 102.

As an example, a drone, other unmanned, optionally aerial, vehicle or generally some other type of a sensor/camera carrying (user) device may be used to supply video data and optionally additional data such as sensor data. The item may be transmitted to a first user device 104. Such data thus originally potentially obtained from a connected video capturing device 105 may then be received by the processor 102 via the first user device 104.

In an embodiment, the arrangement 100 comprises a first user application 118 in connection with the first user device 104. The first user application 118 may provide a first user interface 120, which may enable recording of video content by the first user device 104 and provide information regarding the video content and/or the sensor data that is being acquired.

The video item received from the first user device 104 may be stored in a database 122, which the processor 102 may have access to, both of which may be comprised in a server apparatus.

The processor 102 may be configured to use the data received through a first user device 104 to perform automatic tagging (assigning e.g. a keyword or other descriptor that can be searched) of at least one received video item. Here, the data may refer to the data obtained through sensors of the first user device 104 and also additionally to other data that may be received from the first user device 104 in conjunction with the video item, such as data regarding the time that the video item was captured. In an advantageous embodiment, at least the time is added in a metadata file, field, portion or other data element associated with the video content, i.e., the video item is tagged with at least temporal information.

The processor 102 may comprise or have access to a sensor data analysis module 124, which may be used to analyze the received video item or other data content and additionally may also be utilized in automatic tagging. Alternatively or additionally, some tagging could take place at the user device 104. The sensor data analysis module may comprise means for analysis of different types of sensor data or metadata associated with a received video item.

Information from, e.g., a GPS sensor 114 may be used to determine a location in which a video item has been captured. In advantageous embodiments, in addition to temporal information, the received video material may be automatically tagged with information regarding data received through a GPS sensor 112, i.e., the location in which video content has been captured. Sensor such as GPS based data may be included in a tag as such, and/or higher-level location data be derived therefrom, e.g. address, landmark, district, building, city, country and/or event data (when combined with temporal/time data and schedule data regarding different events and their locations).

Sensor data from sensors such as a camera 106, magnetometer 108, an accelerometer 110, and/or a gyroscope 116, may be analyzed by the sensor data analysis module 124 to create metadata and metadata based tags that are related to e.g. field of view or viewing angle, or ‘watching direction’, of the captured video content.

The sensor data may in some embodiments be used to determine metadata that is indicative of quality of the video material. The arrangement 102 may through the sensor data analysis module 124 determine, e.g., if the first user device 104 has been shaking during the capturing of the video material. This information may be utilized in tagging. In some embodiments, the aforementioned information may also be used to automatically enhance video quality by a stabilization algorithm, for instance. Additionally or alternatively, in some embodiments shaking may be detected directly from the captured video data based on image analysis.

Other quality associated data or similar parameters, such as video resolution, brightness, and/or acutance (sharpness), may also be determined by an arrangement 100 through analysis of the video item and/or sensor data associated therewith. The parameters may be further analyzed to determine e.g. a characterizing value on a scale or some other criteria that may be employed to indicate the quality of a video item. The video item may then also be tagged with the respective quality information for search and/or compilation purposes.

Advantageously, one or more quality parameters may be evaluated for a video subitem in addition to or instead of general parameters regarding the item as a whole. For example, a video item may be related to a temporal duration, and may be divided into two or more subitems, which may be related to temporal subdurations. These subdurations may be mutually of equal or different length (duration). For example, the subitems may be video segments or video frames. In some embodiments, the device 104 or processor 102 may be configured to divide the video item into subitems based on e.g. recognized video (image) content, quality and/or other parameters of the underlying video or related sensor data. In some other embodiments, the subitems may be created automatically responsive to user input; for example, each recording pause instructed by the user via the UI may translate into switching over to a new subitem. The subitems may be determined as having discrete or overlapping durations relative to the overall item. In an embodiment, each of the video subitems is assigned at least one quality parameter.

In view of the foregoing, the sensor data analysis module 124 may comprise means for image analysis, which may utilize various methods of computer vision and pattern recognition. The image analysis may be utilized to detect, classify and/or identify e.g. objects appearing in video content, and also be capable of more complicated image analysis, such as facial recognition. Accordingly, related metadata such as tags may be associated with the video item. The image analysis may additionally comprise methods where also other sensor data, such as auditory data from a microphone 112 is utilized to analyse complex events and provide information on semantic content that may be detected or determined through video material and possible other available sensor data.

In one embodiment, an arrangement 100 may comprise a video compilation module 126, which may combine two or more video items or subitems of one or more video items to create a compiled video. The video items may be received from one or several different first user devices 104 in the possession of one or more users. The video compilation module 126 may be utilized to create a compiled video of, e.g., an event, where only video items or subitems of desired (user-selected) kind, e.g. video items or subitems that have quality criteria matching or exceeding a certain limit, may be used or at least preferred over other items/subitems. Compiled videos where an event or object of interest may be viewed or shown from various different angles may also be created. A user requesting the compilation may preferably define characteristics of the compilation to be established based on available video data, said characteristics possibly including quality characteristics, temporal characteristics (e.g. may the compilation have temporally overlapping portions, or should it be temporally more linear or strictly chronological), angle of view/shooting direction/shooting location related preferences, target object or person preferences, use of slow-motion or other effects (e.g. transitional effects) related preferences, etc.

The video compilation module 126 thereby enables compiling videos from an event with various video items or subitems featuring an entity that may be defined through image analysis. As an example, a compilation video from a certain sports event may feature a certain player, or a compilation video from a certain cultural event such as a concert may feature a certain artist.

In the video compilation module 126, the creation of compilation videos may be further enabled through the use of the sensor data analysis module 124. Video subitems, such as segments or frames, may be analyzed separately, and a compilation video with high quality featuring an event or an entity of interest may be generated where video subitems appear in chronological order, as temporal information is also utilized in the arrangement 100.

The video compilation module 126 may incorporate into a compilation video data from a plurality of video (image) sensors comprised in a first user device 104. Alternatively of additionally, data from some other data source of the device 104 or a further device may be integrated with a compilation video. For instance, if a video compilation from an event such as a concert, other cultural event or a sports event is created, sensor data such as sound from a microphone 112 may be added as a sound track to the video. The microphone 112 or other sensor data may originate from the same first user device 104 that has been used to capture the video content or another first user device 104. Also external data, such as an external sound track, may be added.

In other instances, an arrangement 100 may through the video compilation module 126 and image analysis determine semantic content or context of a video and automatically generate a compilation video and optionally also include external data pertinent to the detected context. For instance, an arrangement 100 may identify events or situations happening in a video or videos, for instance that the video content has been captured during a wedding and add an appropriate sound track tagged as wedding type music.

In an advantageous embodiment, a processor 102 may receive, possibly through a second user device 128 utilizing a second user application 130 and a second user interface 132, a search query for a video or compilation. The search query may cause the processor 102 to conduct a search and identify video items stored in the database 122 that match the search query. The processor 102 may then communicate to a user of the second user device 128 the results of the search through providing an output and facilitate access of said user to the video item search results.

In one embodiment of the present invention, a search query comprises at least a time and/or a location. Any number of other search criteria may also be added. Advantageously, at least one of the search criteria is related to the metadata or associated tags that have been received or created by an arrangement 100. A search query may also indicate e.g. the name of an event such as a concert or sports event.

Through the second user interface 132, the output provided by the arrangement 100 may be indicative of the characteristics such as the quality of the video item search results. The quality may be related to quality parameters obtained through analysis of the at least one video item and/or other sensor data.

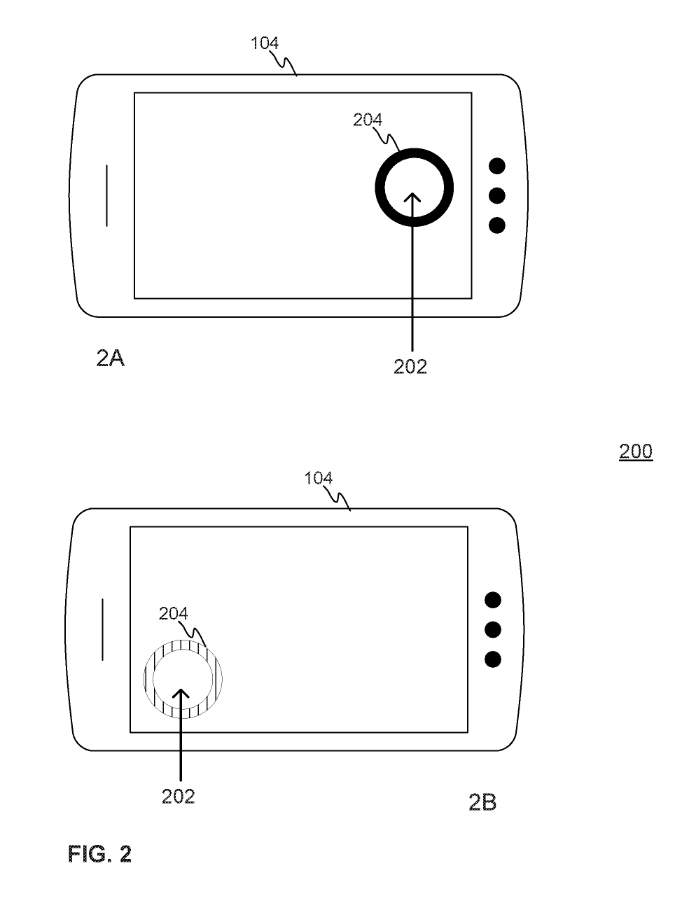

FIG. 2 shows two views, 2A and 2B, of an exemplary application view 200 in a depiction of a first user interface 120, which may be provided through a first user application 118, the first user interface 120 intended for use with a first user device 104. The first user interface 120 may comprise a multifunctional record feature essentially in the form or shape of e.g. button 202, which may comprise an outer portion such as an outer rim 204. In the embodiment of FIG. 2, the multifunctional record button 202 is shown on a screen of the first user device 140 and thereby implemented as a touch-sensitive icon displayed, whereupon pressing the multifunctional record button 202 may result in initiating or terminating recording of video content with the first user device 104. In some embodiments, initiation or termination of video recording may be done through some other method, such as auditory methods based on the analysis of microphone-captured sound data such as voice commands.

In an embodiment, the outer rim 204 may visually indicate to a content providing user of the first user device 104 information regarding the video content that is being recorded by the first user device 104 or may be recorded at that particular instant in time. The information may be related to e.g. video quality. For example, a color or pattern may be presented on the outer rim 204 which may be indicative of video quality and/or some other video related characteristics or information.

In one embodiment, the first user application 118 may communicate to a user of the first user device 104 information related to video content through haptic feedback initiated through the first user device 104. For instance, if a video is being recorded by the first user device 104 and the first user device 104 is tilted during the recording, haptic feedback via e.g. a vibration element may inform the user of the first device 104 of the tilting. This may be advantageous e.g. in a situation where video content is being recorded by a handheld device such as a mobile phone and a user of the device is not constantly looking at the device or the video content that is being recorded, and may want to focus their attention or gaze on something else, while still obtaining video material of high quality.

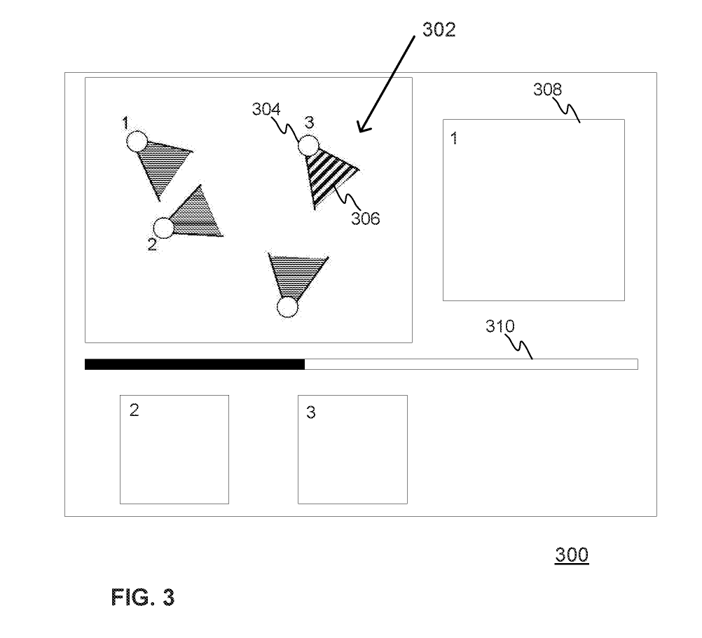

In FIG. 3, an exemplary depiction of an application view 300 of a second user interface 132 is shown. FIG. 3 specifically illustrates a possible schematic appearance of an application view that may comprise an output that may be provided by an arrangement 100 in response to a search query. The application view 300 may comprise e.g. a map or other location-indicating view 302. The view 302 may show an area representative of a geographical location that is specified through the search query or show an area that comprises the location explicitly (e.g. location name, address, coordinates, etc.) or implicitly (e.g. event) specified in the search query. The area to be shown may be predetermined as to related one or more parameters such as coverage. For example, it may be specified that the map view 302 initially shows an area comprising of 1 square kilometer. In a preferred embodiment, the searching user may manipulate the map view 302 via the UI in order to navigate surrounding areas and/or e.g. zoom in and out.

The map view 302 may visually indicate geographical points corresponding to locations where at least one first user device 104 has captured video content at a specific time. This may be done by e.g. placing points, circles or other pointers 304 on a map view 302.

The map view 302 may also visually indicate the quality of the video material. In an embodiment, a quality parameter relating to the video subitem in question may be indicated to a user through e.g. a color or pattern which may displayed on the map view 302. Also other indicators may be used, such as a percentage or a number, for instance.

The field of view 306, shooting direction and/or similar characteristics of a video item at a specific time may also be visually and preferably dynamically (i.e. changing in accordance with e.g. shown video 308) indicated on the map view 302, which may also comprise the indication of a quality parameter as discussed above. Such an implementation is indeed shown in FIG. 3.

The application view 300 may in one embodiment also show a preview 308 of one or more video items. A preview may be shown for one or more video items indicated in the map view 302. The video items for which previews are currently provided may be selected by the arrangement 100 according to some criterion or may be selected by a searching user through, e.g., clicking on the circles 304 or other visual indicators associated with video items.

An application view 300 may additionally comprise a timeline 310, through which a searching user may navigate the video items that are depicted on a map view 302. A searching user may, for instance, manipulate the timeline to directly or gradually proceed to certain time and the map view 302 and preview(s) 308 may change accordingly. A timeline may also be allowed to proceed in real time and the preview(s) 308 may play the selected video item(s) accordingly, while the map view 302 may also change accordingly.

Other ways of manipulating the timeline 310 may also be made possible, such as e.g. “fast forwarding” or proceeding on the timeline in a time scale that is faster than real time with the preview(s) 308 and map view 302 changing accordingly. The timeline may also be navigated in the opposite direction, i.e., one may move backwards in time on the timeline.

Because of the possible vast amount of available video material, search criteria may yield a number of video item search results that are too large for practical considerations based on e.g. user-defined settings. In an embodiment of the present invention, it may be possible to filter search results for example through an area density filter. It may be specified, for instance, that an output may give only a certain number of video items captured within a certain area or essentially location. E.g., it may be specified that only one video item per five square meters is to be shown in the output, where shown video items are those meeting the search criteria which exhibit a highest quality and/or other criterion, which may advantageously be user adjustable. Other specifications may also be made to filter search results, such as showing in the output only video items with a specific field of view or shooting direction. Generally, filtering may in different embodiments be done when configuring the second user application 130 and second user interface 132 or it may be done by a searching user e.g. through the second user interface 132.

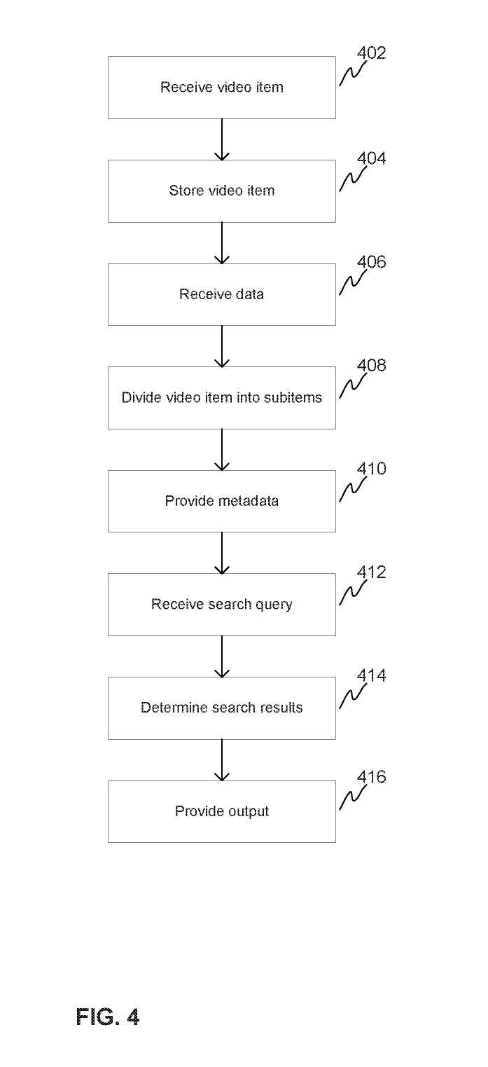

FIG. 4 shows steps that may be performed in a method according to an embodiment of the present invention. In 402, one or more video items are received from a number of first user devices, whereby the video items are stored in a database 122 in 404. Supplementary data is received in 406, the data being provided through the device with which said at least one video item has been recorded. In a preferred embodiment, the data may be provided by one or more sensors comprised in the first user device(s) 104. The data may also comprise temporal data (time, timecode, clock, sync, etc.) provided through the first user device(s) 104.

In an advantageous embodiment, the one or more video items relating to initial time duration are divided into a plurality of discrete or overlapping subitems related to corresponding subdurations in 408 as contemplated hereinbefore.

In step 410, metadata is provided preferably in connection with video items or even specific subitems (e.g. subitem-specific dedicated quality indicators), the metadata being obtained through utilizing the received supplementary data. The metadata may be created by the sensor data analysis module 124.

In some embodiments, metadata may be assigned to (associated with) one or more video items and/or related subitems as related searchable and preferably also inspectable tags. E.g., one or more quality indicating parameters may be assigned to each video subitem to enable quality-based searches.

A search query may be received in 412, and video item search results matching the search query may be determined in 414, after which in step 416, an output indicative of the video item search results may be provided. In some embodiments, the output may include at least a listing of the video items of the results group, which may contain at least one video item. In some embodiments, the output may include the actual video item(s).

In some embodiments, a video compilation typically based on a plurality of originally discrete video items, fulfilling the user-defined criteria such as temporospatial criteria (time, location, event, etc.) may be established either fully automatically or in a user-assisted fashion. The compilation may be provided as the outputted video item. The compilation may comprise a single video stream or a video file constructed from the constituent (source) video items preferably best fulfilling the criteria, for example.

The invention has been explained above with reference to the aforementioned embodiments, and several advantages of the invention have been demonstrated. It is clear that the invention is not only restricted to these embodiments, but comprises all possible embodiments within the spirit and scope of inventive thought and the following patent claims.

The features recited in dependent claims are mutually freely combinable unless otherwise explicitly stated.

1. An arrangement, optionally comprising one or more network accessible servers, for searching for digital video material, wherein the arrangement comprises at least one processor configured to
receive a number of video items;
store the video items in a database;
provide metadata, preferably a number of tags, for any or each video item wherein said metadata is obtained through utilizing supplementary data provided by at least one user device via which said video item has been respectively obtained, said user device comprising e.g. a user terminal capable of autonomous video capturing and/or of receiving and forwarding video data from a connected video capturing device such as a drone;
receive a search query wherein at least one search criterion comprised in the search query is related to said metadata;
determine video item search results matching the search query among said at least one video item stored in the database; and
provide an output to a user comprising the video item search results,
wherein the video item is related to time duration and said provided metadata comprises at least one quality indicator, which is determined through analysis of said supplementary data related to one or more subitems of the video item, wherein a subitem is related to a subduration of thereof, and said at least one quality indicator is assigned to a corresponding subitem.

2. The arrangement of claim 1, wherein the video item is divided into a plurality of subdurations, giving a plurality of subitems and at least one quality indicator is determined and assigned to each of said subitems.

3. The arrangement of claim 1, wherein the output is indicative of said at least one quality indicator.

4. The arrangement of claim 1, wherein at least part of the metadata is obtained through utilizing data provided by one or more sensors, at least one of said sensors being selected from the group consisting of: a camera, thermal imaging camera, image sensor, a magnetometer, an accelerometer, a microphone, a location sensor, a satellite positioning based location sensor, a GPS sensor, pressure sensor, temperature sensor, moisture sensor, and a gyroscope.

5. The arrangement of claim 1, wherein the metadata comprises indication of time and/or location, which is obtained via the user device.

6. The arrangement of claim 1, wherein the search query comprises at least a time and a location as search criteria.

7. The arrangement of claim 1, wherein the output comprises a selected, optionally user-selected, number of video item search results within a selected, optionally user-selected, location range, where all video item search results within the location range are arranged according to a selected criterion.

8. The arrangement of claim 7, wherein the criterion is related to video quality.

9. The arrangement of claim 1, configured to determine, for the video item, metadata such as a tag indicative of an event, optionally a cultural, sports or party event, associated with the item.

10. The arrangement of claim 9, wherein the event indicating metadata is determined based on the video image data of the item, time data associated with the item, location data associated with the item, microphone-based sound data, and/or other sensor data.

11. The arrangement of claim 9, wherein the event indicating metadata is determined based on event information characterizing the locations and times of at least one event.

12. The arrangement of claim 1, configured to provide a map comprising the location indicated in the search query and a timeline comprising the time indicated in the search query, wherein the map indicates a number of points where a corresponding number of video items have been captured at a time corresponding to the time indicated on the timeline.

13. The arrangement of claim 12, wherein the output provides information concerning the angle of view, shooting direction and/or direction from which video material of a video item has been captured.

14. The arrangement of claim 1, configured to provide a compilation selectively constructed from two or more video items taking into account the search query in selecting the video items and/or in determining their contribution to the compilation.

15. The arrangement of claim 1, comprising said at least one user device, provided with a user interface, wherein the user interface comprises a multifunctional record-button preferably as on-screen symbol, the record button being indicative of the quality of the video material being recorded at a certain time.

16. The arrangement of claim 15, wherein the user interface is configured to enable repositioning of the record-button by a user of the user device.

17. The arrangement of claim 1, wherein the arrangement indicates, via haptic feedback to a user of the user device, a change occurring in the captured video content.

18. The arrangement of claim 17, wherein the change is related to the angle of view or shooting direction regarding a camera of the capturing device and video content captured therewith.

19. A method for searching for video material, comprising:
receiving a number of video items,
storing the video items in a memory, and
providing metadata for any or each video item, wherein said metadata is obtained through utilizing supplementary data provided by at least one user device via which said video item has been obtained,
wherein the video item is related to time duration and said provided metadata comprises at least one quality indicator, which is determined through analysis of said supplementary data related to one or more subitems of the video item, wherein a subitem is related to a subduration thereof, and said at least one quality indicator is assigned to a corresponding subitem.

20. The method of claim 19, further comprising: receiving a search query wherein at least one search criterion comprised in the search query is related to said metadata, determining video item search results matching the search query, and providing an output to a user comprising the video item search results.
